(19) United States
(12) Patent Application Publication
(10) Pub. No.: US 2012/0280555 A1
(43) Pub. Date: Nov. 8, 2012

(54) SEAT COMPONENT FOR A SEAT AND ASSEMBLY WITH SEAT COMPONENT AND ROTATABLE ACTUATING SHAFT

(76) Inventors: André Blinzler, Gochsheim (DE); Matthias Weiß, Rodental (DE); Frieder Krüger, Coburg (DE); Michael Heilingloh, Bad Rodach (DE); Volker Möller, Coburg (DE); Jürgen Siller, Rodental (DE)

(21) Appl. No.: 13/461,354

(22) Filed: May 1, 2012

(30) Foreign Application Priority Data
May 5, 2011 (DE) 10 2011 075 364.8

(51) Int. Cl. B60N 2/44; B60N 2/22; B60N 2/20

(52) U.S. Cl. 297/463.1

(57) ABSTRACT

A seat component for a seat, in particular a vehicle seat, is provided. The seat component is connectable with an actuating shaft such that a rotary movement of the actuating shaft can be transmitted to the seat component, in order to e.g. provide for swiveling a first vehicle part of a vehicle seat relative to a second vehicle part of the vehicle seat. Preferably, swiveling of a backrest is permitted relative to a seat part with a seating surface. The seat component furthermore includes a cutout for connection with an actuating shaft, which is formed and provided for a positive engagement of a shaft portion of the actuating shaft. In accordance with the invention it is provided that the cutout furthermore is formed such that one of at least two shaft portions with different cross-sectional profiles each selectively can positively be held in the cutout.

### REFERENCE TO RELATED APPLICATION

This application claims the benefit of German Patent Application No. 10 2011 075 364.8 filed on May 5, 2011 and is fully incorporated herein by reference.

### BACKGROUND

This invention relates to a seat component for a seat and to an assembly for a vehicle seat.

In a seat, in particular a vehicle seat, a tilt adjustment regularly is provided, in order to swivel a backrest of the seat relative to a seat part with a seating surface. For the tilt adjustment, a fitting usually is provided at the sides of the seat. At least one of the fittings is provided with a latching mechanism, which in a locked condition keeps the backrest and the seat part of the seat in position relative to each other and in an unlocked condition permits swiveling of the backrest relative to the seat part. In this case, the seat fitting with the latching mechanism includes a shiftable seat component, into which an adjustment force initiated by a user can be introduced, in order to switch between the locked and the unlocked condition. An actuating shaft which is non-rotatably connected with the seat component usually engages in such seat component.

By a user now actuating for example an actuating lever fixed at the actuating shaft and thereby rotating the actuating shaft, the seat component is carried along and due to its rotation releases the latching mechanism, so that the backrest can be swiveled relative to the seat part. The seat component for example can constitute a cam disk with eccentrically arranged cams, which in the case of a rotation triggered by the actuating shaft acts on latch elements of the latching mechanism.

To connect the actuating shaft with the rotatable seat component in a manner as time-saving and inexpensive as possible, such that the seat component is carried along with a rotation of the actuating shaft, it is preferred in practice to positively connect the actuating shaft with the seat component. For this purpose, a shaft portion of the actuating shaft is introduced into a cutout of the seat component, which has an inner contour adapted to the profile of the shaft portion. As a result, the introduced shaft portion is positively accommodated in the cutout, so that the seat component is carried along with a rotation of the actuating shaft.

In the industrial manufacture it now can occur that with otherwise identically formed latching mechanisms for a (vehicle) seat, actuating shafts with different cross-sectional profiles must be used. In dependence on the actuating shaft used, a seat component adapted to the cross-sectional profile of this actuating shaft must then be provided, into which the actuating shaft engages in a positive manner.

From DE 10 2008 028475 A1 it is already known to form a seat component (therein referred to as “drive element”) with a cutout such that the inner contour of the cutout is adapted to at least two cross-sectional profiles different from each other. In this way, a shaft portion of a hollow actuating shaft with a first cross-sectional profile or an opposite shaft portion of the same actuating shaft with a second cross-sectional profile can selectively be introduced into the cutout and be connected with the seat component.

DE 10 2008 028475 A1 teaches that due to the inner contour adapted to two cross-sectional profiles a seat component can be mounted on two differently designed ends of an actuating shaft and/or be connected with the same.

In DE 10 2008 028475 A1 it is, however, expressly provided that the different regions inside the cutout of the seat component for the individual cross-sectional profiles at the same time are also designed for different kinds of component connection. For example, three individual pockets are provided for a first cross-sectional profile, in which the shaft portion to be introduced or the shaft end of the actuating shaft to be introduced includes three radially protruding noses which positively engage in the pockets of the cutout of the seat component. In the regions for a second cross-sectional profile, on the other hand, sharp-edged teeth or a sharp-edged knurl are provided on the circumference of the cutout, via which above all a non-positive, non-rotatable fixation at the seat component should be effected by pressing in the shaft portion to be introduced.

In DE 10 2008 028475 A1 it is expressly pointed out that for providing a non-rotatable fixation of the shaft portion with the second cross-sectional profile an adapter bolt must be driven into the hollow actuating shaft, in order to deform the shaft and press the sharp-edged teeth or the sharp-edged knurl of the cutout into the shell surface of the shaft portion. Possibly, this can not only render the assembly process more difficult, but also damage the seat component with the cutout. In addition, with a seat component designed corresponding to DE 10 2008 028475 A1, always only one actuating shaft with a first cross-sectional profile might be positively fixed in the cutout without additional aids, whereas for an actuating shaft with a second cross-sectional profile no axial introduction into a form-fit region of the cutout would be possible, in which the shaft is positively held right away. On the other hand, the actuating shaft with a second cross-sectional profile first would have to be deformed radially, whereby parts of the seat component (the sharp-edged teeth or the sharp-edged knurl for the second cross-sectional profile) would be driven into the shell surface of the shaft portion.

Correspondingly, inside the cutout no region is provided for a shaft portion with a second cross-sectional profile, such that a shaft portion with the second cross-sectional profile can just as easily be introduced into the cutout and is positively mounted in a form-fit region which is designed analogous to the pockets for the first cross-sectional profile.

### SUMMARY

Proceeding from said prior art, it is the object underlying the present invention to develop a seat component such that a damage-free, positive fixation of shaft portions with different cross-sectional profiles in a cutout of the seat component is possible and that in particular actuating shafts with different cross-sectional profiles easily can (non-rotatably) be connected with one and the same seat component without any damages.

A seat component according to an exemplary embodiment of the invention includes a cutout for the connection with an actuating shaft, wherein an inner contour of the cutout is adapted to at least two cross-sectional profiles different from each other, so that a shaft portion of an actuating shaft with a first cross-sectional profile or a shaft portion of an actuating shaft with at least one further, second cross-sectional profile selectively can be introduced into the cutout and be connected with the seat component. The cutout furthermore includes at least two geometrically differently designed form-fit regions for each of the at least two cross-sectional profiles, which are formed such that each shaft portion with one of the at least two cross-sectional profiles can slidingly be introduced into at least one, respectively suitable form-fit region and is positively accommodated therein.

Correspondingly, it is provided in accordance with the invention that the cutout is formed such that via form-fit regions of the cutout one of at least two shaft portions with a different cross-sectional profile each selectively can positively be held in the cutout. A shaft portion with one of the at least two (permitted or specified) cross-sectional profiles thus can always be introduced axially into the cutout (along a direction of longitudinal extension of the actuating shaft) and into the associated at least one form-fit region such that the introduced shaft portion is positively accommodated in the form-fit region and the actuating shaft is (non-rotatably) connected with the seat component such that the seat component is carried along by the actuating shaft, when the actuating shaft rotates.

Thus, it is an essential aspect of the present invention that at least two different form-fit regions adapted to one cross-sectional profile each are provided, which are formed and arranged such that a shaft portion with one of the two cross-sectional profiles must be inserted into at least one of the at least two form-fit regions, in order to be able to introduce the shaft portion into the cutout as intended. The form-fit regions thus are formed such that a shaft portion with one of the at least two cross-sectional profiles, which is introduced into the cutout, always engages in at least one (suitable) form-fit region and is positively accommodated in the cutout via this form-fit region.

The inner contour of the cutout of the seat component accordingly is designed such that regions on the circumference of the shaft portion with one of the at least two provided cross-sectional profiles, which is introduced or is to be introduced, can slidingly be introduced or inserted into the form-fit regions and are positively accommodated in at least one form-fit region (or also several form-fit regions) of the cutout, without a deformation of the form-fit regions or the regions on the circumference of the shaft portion being necessary. A shaft portion with a provided cross-sectional profile thus in part directly rests against the inner contour or an inner shell surface of the cutout and is (exclusively) posivitely mounted in the cutout.

Accordingly, the cutout has an inner contour in which at least two profiles are superimposed or are arranged one behind the other along an insertion direction, so that a shaft portion of an actuating shaft with one of the permitted cross-sectional profiles can be axially be inserted into the cutout and at least one form-fit region which positively accommodates the shaft portion and retains the seat component at the actuating shaft.

At this point, it should also be noted that the “introducability” of a shaft portion into the cutout of the seat component also is understood to the effect that during an assembly the seat component can of course also be pushed or put onto a shaft portion the other way round.

In one exemplary embodiment, at least one form-fit region for a cross-sectional profile is defined by a plurality of segments spaced from each other. The individual segments are spaced from each other either in axial and/or radial direction (relative to an actuating shaft introduced into the cutout) and together define an inner contour corresponding with the outer contour of the shaft portion to be accommodated. The individual segments each provide contact surfaces, against which a shaft portion introduced as intended rests at least with parts of its outer shell surface. Individual segments can be formed as radial recesses or pockets, into which a part of the shaft portion can slidingly be introduced and can be held in a positive manner.

In accordance with an exemplary development it is provided that at least two form-fit regions each include a plurality of segments and the segments are formed and arranged such that in a first shaft portion with a first cross-sectional profile, which is to be connected with the seat component, first segments positively accommodate the first shaft portion, and in a second shaft portion with a second cross-sectional profile different from the first cross-sectional profile the shaft portion is positively accommodated by segments which are different from the first segments. The individual segments which define a form-fit region for a cross-sectional profile thus differ for example by their geometrical shape and/or their number.

In addition, it is furthermore conceivable that an individual segment or individual segments can be assigned to several (at least two) form-fit regions, i.e. both a shaft portion with a first cross-sectional profile and a shaft portion with a second cross-sectional profile would positively engage in this segment or would at least rest against a contact surface provided by the same. Merely the segments additionally provided for each of the different cross-sectional profiles would be different.

By way of example, this will be described in detail below with reference to a design variant (not illustrated in the Figures yet to be explained below), in which individual radial recesses or pockets spaced from each other are provided as segments in the cutout. A part of the pockets might be wedge-shaped in cross-section and another part might be semicircular in cross-section. A first form-fit region now would be formed by three segments in the form of wedge-shaped pockets A, B and C, and a second form-fit region would be formed by two semicircular pockets D, E and by the wedge-shaped pocket C. A shaft portion with a first cross-sectional profile, which is to be introduced as intended, correspondingly would have three cams wedge-shaped in cross-section or three radially protruding protrusions, which can be introduced into the pockets A, B and C. A shaft portion with a second cross-sectional profile, on the other hand, would have two cams/protrusions semicircular in cross-section, which can be introduced into the pockets D and E, and a cam/protrusion wedge-shaped in cross-section, which can be introduced into the pocket C. The pocket C thus forms a segment both of a first form-fit region and of a second form-fit region.

In one exemplary embodiment of a seat component according to the invention it is provided that segments for a first cross-sectional profile and segments for a second cross-sectional profile are arranged one beside the other along an inner shell surface of the cutout. The inner shell surface at least partly surrounds a shaft portion of an actuating shaft connected with the seat component as intended. The individual segments for the cross-sectional profiles thus define superimposed contours inside the cutout, which correspond with the respective cross-sectional profiles.

Preferably, a plurality of segments for two different cross-sectional profiles are alternately arranged along the inner shell surface of the cutout. It is particularly preferred when in a cross-sectional view through the cutout the segments for the different cross-sectional profiles at least partly lie within one sectional plane. This (cross-) sectional plane substantially extends vertical to an insertion direction, along which the shaft portion of the actuating shaft to be connected with the seat component must be introduced into the cutout as intended, or along which the seat component must be pushed onto the corresponding shaft portion of the actuating shaft.

While in such an embodiment the cutout has an inner contour visible in a cross-sectional view, in which the different form-fit regions for the at least two or both cross-sectional profiles superimpose each other, it is provided in an alternative or additional variant that a form-fit region for a first cross-sectional profile and at least one form-fit region for a second cross-sectional profile are arranged one behind the other along a direction of extension of the cutout. The direction of extension extends substantially parallel to the insertion direction, along which the shaft portion of an actuating shaft to be connected with the seat component must be introduced into the cutout.

In this case, form-fit regions for different cross-sectional profiles of an actuating shaft or form-fit regions for actuating shafts with different cross-sectional profiles thus succeed each other or are arranged one behind the other along a direction of longitudinal extension of an actuating shaft connected with the seat component as intended. Along the direction of extension, the inner contour of the cutout thus has at least two profiles different from each other. The different profiles thus lie in different (cross-sectional) planes of the cutout parallel to each other.

Along its direction of extension or along the insertion direction, the cutout can have different internal dimensions, so that a shaft portion with a second cross-sectional profile along the direction of extension can be guided past the at least one form-fit region for a first cross-sectional profile and can be introduced into the at least one form-fit region for the second cross-sectional profile, which lies behind the same in direction of extension.

Such variant also can easily be expanded to the effect that in a first partial region of the cutout with a larger diameter a form-fit region is provided and in a second partial region of the cutout with a smaller diameter, which follows in direction of extension, two further form-fit regions are formed. For example, the form-fit region in a first partial region for a shaft portion is formed with a triangular profile, while in the second partial region two superimposed form-fit regions are formed for a triangular and a square profile of smaller diameter. Accordingly, a shaft portion with a triangular or a square profile, which corresponds with the second partial region, might be introduced or inserted through the first partial region into the second partial region, in order to positively connect the same with the seat component in the second partial region.

Alternatively, it would also be conceivable that the differently formed partial regions arranged one beside the other of a cutout of the seat component define openings located opposite each other, which each lie on one side of the seat component. Such seat component correspondingly would be usable on both sides of a (vehicle) seat, wherein depending on the location of the seat component on the one or the other side, the one or the other partial region is provided for positively accommodating a shaft portion of an actuating shaft. Such seat component thus is usable both for a left and a right seat half or (in a motor vehicle) both for a tunnel-side and a door-side seat half. Depending on its location, the seat component thus accommodates a shaft portion in the one partial region for a first cross-sectional profile or a shaft portion in the other partial region for a second cross-sectional profile, wherein the shaft portion extends either through a first (left) opening of the seat component (when mounted on the right seat half) or through a second (right) opening of the seat component (when mounted on the left seat half).

It should also be noted that a cross-sectional view always is understood to be a section vertical to the insertion direction and hence vertical to the direction of longitudinal extension of an actuating shaft connected with the seat component as intended.

In one exemplary embodiment, the inner contour of the cutout is formed for positively accommodating a shaft portion with substantially rectangular cross-sectional profile, in particular for positively accommodating a shaft portion with a square profile.

In an exemplary development based thereon, the inner contour of the cutout furthermore is formed for accommodating a shaft portion with a triangular or pentagonal profile. In these cases, the inner contour of the cutout thus is formed for positively accommodating a square profile and a triangular profile or a square profile and a pentagonal profile as first and second cross-sectional profiles.

In one exemplary embodiment, the seat component is formed and provided as part of a seat fitting for a vehicle seat, in particular such that on the seat fitting arranged on one side of the vehicle seat, at least two shaft portions with different cross-sectional profiles selectively are positively connectable as intended by means of the seat component.

Hence, an introduction and positive connection of shaft portions with different cross-sectional profiles is possible on a seat component of a seat fitting which is arranged on one and the same side of a (vehicle) seat. Depending on the required cross-sectional profile of the shaft portion or the actuating shaft, the same (both) can slidingly be introduced into the cutout and are equally positively accommodated there in an effective manner. Thus, a fitting arrangement with a seat fitting in particular can be provided, which is arranged on one side of a (vehicle) seat and whose seat component selectively is connectable with actuating shafts of different cross-sectional profiles, in that a shaft portion of the respective actuating shaft merely is inserted into the cutout of the seat component provided for this purpose. Since all permitted different cross-sectional profiles are depicted in the cutout and can positively be accommodated therein, it is not necessary to provide another seat component.

Furthermore, it is preferred to form the cutout as a through opening in the seat component.

A further aspect of the present invention is the creation of an assembly, which beside a seat component comprises an actuating shaft. The seat component is connectable with the actuating shaft such that a rotary movement of the actuating shaft can be transmitted to the seat component, in order to provide for swiveling a first vehicle part of a vehicle seat relative to a second vehicle part of the vehicle seat. The first vehicle part for example is a backrest which can be swiveled relative to a seat part as second vehicle part.

Here as well, it is essential for the invention that the cutout includes at least two geometrically differently designed form-fit regions for each of the at least two cross-sectional profiles, which are formed such that each shaft portion with one of the at least two cross-sectional profiles can slidingly be introduced into at least one, respectively suitable form-fit region and is (exclusively) positively accommodated therein.

In a preferred design variant it is provided that the assembly comprises a set of at least two actuating shafts and the shaft portions of the at least two actuating shafts, which each are provided for the positive connection with the at least one form-fit region, have the cross-sectional profiles different from each other, so that each of the at least two actuating shafts selectively can positively be connected with the seat component via the cutout. Accordingly, it is possible for example to selectively positively connect different shaft profiles for e.g. an electrically and a manually operable latching mechanism of a seat fitting with an identical seat component on the seat fitting.

A seat component for example acts as drive element of a latching mechanism, via which one can switch between an unlocked and a locked condition and swiveling of the two vehicle parts of a vehicle seat relative to each other can be permitted. The seat component in particular can be formed as cam disk which via cams radially protruding along its circumference acts on a latching mechanism of the associated seat fitting, in order to release a locking of the latching mechanism and provide for swiveling two vehicle parts, e.g. backrest and seat part, relative to each other. Depending on the application, the desired actuating shaft thus can be selected and be introduced into the adapted inner contour of the cutout of the seat component, whereby the respective actuating shaft is positively connected with the seat component.

Alternatively or in addition to a configuration of an assembly according to the invention with a set of at least two actuating shafts with different cross-sectional profiles, an assembly also can comprise an actuating shaft which includes at least two shaft portions arranged one behind the other along its direction of longitudinal extension, which have cross-sectional profiles different from each other. The shaft portions are formed such that they can both be introduced into the cutout of the seat component along an insertion direction and each can positively be accommodated in at least one of the form-fit regions of the cutout, so that in dependence on the length with which the actuating shaft still protrudes from the cutout against the insertion direction, the one or the other of the at least two shaft portions positively engages in the cutout. Depending on how far the actuating shaft is introduced into the cutout, the one or the other of the shaft portions thus makes the positive connection with the seat component.

Preferably, the seat component is made of a plastic material. The actuating shaft in turn preferably is made of a metallic material.

Via a seat component according to the invention and an assembly according to the invention, a fitting arrangement for a (vehicle) seat thus can be provided, in which a first seat component is part of a first seat fitting and a second seat component is part of a second seat fitting and both seat components are connected with each other via an actuating shaft. At least one of the seat fittings then is formed to keep the two vehicle parts of the vehicle seat in position relative to each other in a locked condition, and in an unlocked condition permit swiveling of the two seat components relative to each other. Via the formation of a seat component connected with the actuating shaft in accordance with the invention, actuating shafts with different cross-sectional profiles also can positively be connected with each other at low cost, without any tool and without an additional material deformation on the seat component or on the actuating shaft, by merely inserting seat component and actuating shaft into each other.

### BRIEF DESCRIPTION OF THE DRAWINGS

In addition, further advantages and features of the present invention will become apparent with reference to the following description of exemplary embodiments represented in the Figures:

FIG. 1 schematically shows a vehicle seat with a backrest adjustable relative to a seat part and two seat fittings connected with each other via an actuating shaft.

FIG. 2A shows a cross-sectional view through a first embodiment of a seat component according to the invention, which in a first partial region includes a form-fit region for a first cross-sectional profile.

FIG. 2B shows a cross-sectional view of the seat component of FIG. 2A in a further, second partial region with a form-fit region for a second cross-sectional profile.

FIG. 3 shows a cross-sectional view of a further embodiment of a seat component according to the invention with two superimposed form-fit regions for two cross-sectional profiles different from each other.

FIGS. 4A-4B show the seat component of FIG. 3 in a corresponding view with one introduced shaft portion each with a first and a second cross-sectional profile.

FIG. 5 shows a cross-sectional view of a further embodiment of a seat component according to the invention with two superimposed form-fit regions for two cross-sectional profiles different from each other.

### DETAILED DESCRIPTION

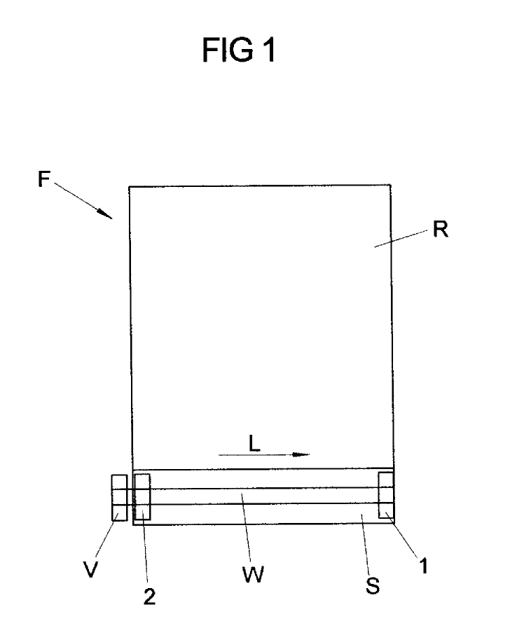

FIG. 1 schematically shows a vehicle seat F with a backrest R and a seat part S which has a seating surface for a user. The backrest R and the seat part S represent vehicle parts which can be swiveled relative to each other. The backrest R in particular can be tilted relative to the seat part S, in order to adapt it to a desired seating position or completely fold it forwards onto the seating surface of the seat part S.

The pivotability of the backrest R relative to the seat part S is provided by two seat fittings 1, 2. The seat fittings 1, 2 each are arranged on one side of the vehicle seat F and usually include two fitting parts each, of which one fitting part each is arranged on the backrest R and a further fitting part is arranged on the seat part S. One of the seat fittings (here the seat fitting 2) is arranged—when the vehicle seat F is mounted in the interior space of a motor vehicle as intended—adjacent to a motor vehicle door and accordingly also is referred to as door-side seat fitting. The opposite seat fitting (1) then is referred to as tunnel-side seat fitting.

To keep the backrest R and the seat part S in a position relative to each other, a latching mechanism not shown here in detail is provided on at least one of the seat fittings 1, 2—preferably on both seat fittings 1, 2. The latching mechanism keeps the backrest R and the seat part S in a relative position to each other and thus locks the two vehicle parts R, S relative to each other. In an unlocked condition, the latching mechanism permits swiveling of the backrest R relative to the seat part S.

For switching from the locked into the unlocked condition of the latching mechanism, an adjusting means V is provided. This adjusting means V can be manually operable by a user and for example include an actuating lever to be seized by a user. However, it is of course also possible that the adjusting means V includes a motorized drive which is actuated via an electronic control unit for seat adjustment.

To be able to perform an unlocking of the latching mechanism on the seat fittings 1, 2 via the adjusting means V, the adjusting means V engages an actuating shaft W which extends from a (door-side) seat fitting 2 to the other (tunnel-side) seat fitting 1 along a direction of longitudinal extension L and connects the two seat fittings 1, 2 with each other. In both seat fittings 1, 2, the actuating shaft W engages in a cutout of a seat component of the respective seat fitting 1 or 2 and is connected with the same such that a rotary movement of the actuating shaft W can be transmitted to the respective seat component. During a rotation of the actuating shaft W, the respective seat component thus is carried along by the same. The seat component carried along acts on the respective latching mechanism on the seat fitting 1 and/or 2 and thereby releases a locking of the latching mechanism, so that the backrest R is pivotable relative to the seat part S.

In practice, actuating shafts W with different cross-sectional profiles often are used for different vehicle seats F. Depending on the cross-sectional profile, a seat component with a cutout with an inner contour adapted to the respective cross-sectional profile then is selected, so that for the different actuating shafts different seat components must be kept on stock for installation in a seat fitting 1, 2.

It should furthermore be noted that to facilitate assembly, one of the seat components on a seat fitting 1 or 2 regularly should be insertable into the cutout of the seat component provided for this purpose and should positively be retained therein. Thus, the actuating shaft W for example can be inserted in the tunnel-side seat fitting 1 and (positively and non-rotatably) be connected there with the corresponding seat component, whereas on the opposite, door-side seat fitting 2 a chiefly non-positive connection is realized. This has the advantage that the actuating shaft W already introduced into the one seat fitting 1 still remains rotatable relative to the seat component of the other seat fitting 2 and thus can still be aligned before being fixed at the seat component of the seat fitting 2. Such assembly operation also is described for example in DE 10 2008 028 475 A1.

At present, a different seat component is used at least on the (tunnel-side) seat fitting 1 on which merely a positive connection of the actuating shaft W is made, in dependence on the cross-sectional profile of the actuating shaft W or the cross-sectional profile of the shaft portion to be introduced.

A seat component according to the invention now is provided with a cutout which includes at least two geometrically differently designed form-fit regions for at least two cross-sectional profiles. The form-fit regions each are formed such that each shaft portion with one of the at least two cross-sectional profiles can be inserted or slidingly be introduced into at least one respectively suitable form-fit region and is positively accommodated therein. Thus, shaft portions with one of the at least two given cross-sectional profiles selectively can be introduced into the cutout of the corresponding seat component such that they are each positively accommodated in the cutout.

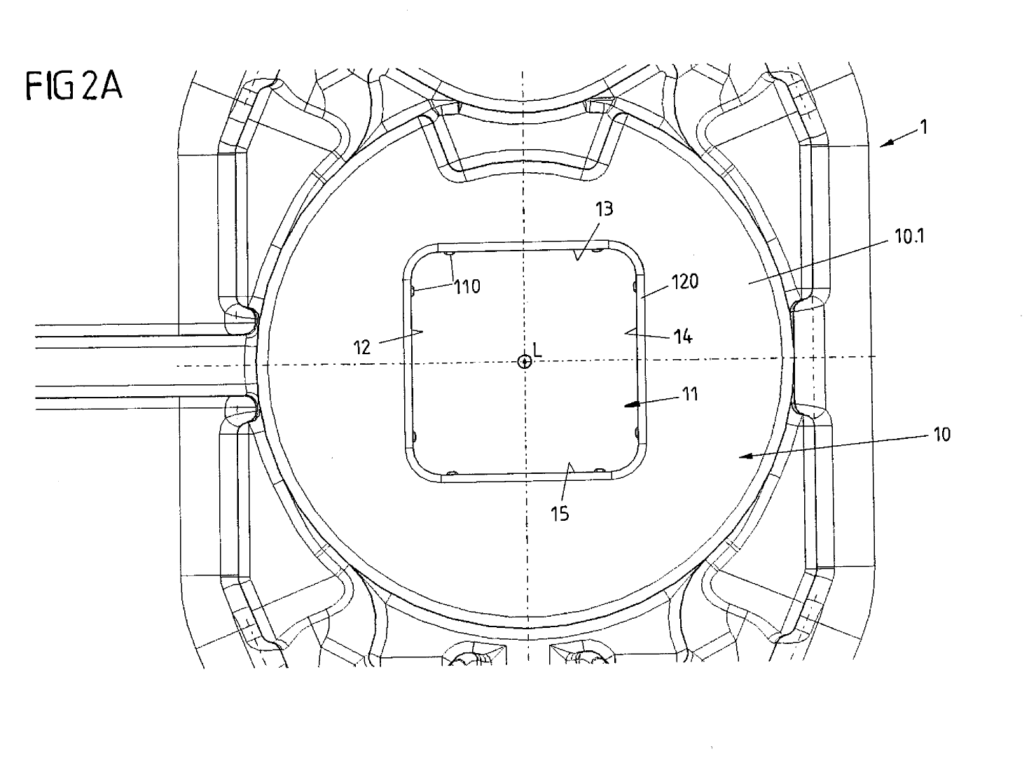

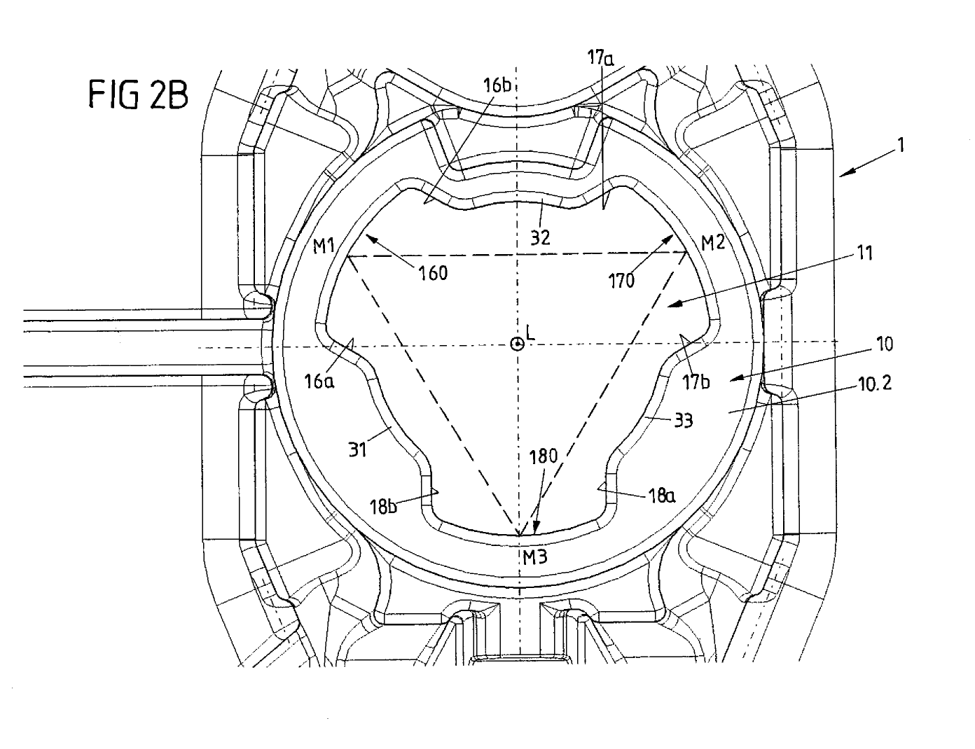

FIGS. 2A and 2B illustrate a first example of an inventive seat component 10 of the tunnel-side seat fitting 1 in two different cross-sectional views.

The seat component 10 includes a cutout 11 which extends along a direction of extension beyond two partial regions 10.1 and 10.2 with two different profiles and internal dimensions. The two partial regions 10.1 and 10.2 thus are arranged one behind the other along an insertion direction, along which the actuating shaft W must be introduced into the cutout 11 and, when the actuating shaft W is introduced as intended, correspondingly lie one behind the other in direction of longitudinal extension L of the actuating shaft W.

As can be taken from the two cross-sectional views shown in FIGS. 2A and 2B, the cutout 11 extending through the two partial regions 10.1 and 10.2 of the seat component 10 is formed with two geometrically differently designed form-fit regions 120, 160+170+180 along the direction of extension or the direction of longitudinal extension L. This means that the cutout 11 here has two different inner contours or profiles lying one behind the other, in each of which a shaft portion with a corresponding cross-sectional profile can positively be accommodated.

The form-fit region 120 in the one partial region 10.1 of the seat component 10 is defined by an inner contour substantially square in cross-section and in direction of longitudinal extension L is located behind the partial region 10.2 shown in FIG. 2B, i.e. is located further to the right inside the seat fitting 1 with reference to FIG. 1.

The form-fit region 120 thus is formed to accommodate a shaft portion with a square profile. For this purpose, the form-fit region 120 each includes two pairs of functional surfaces 12, 14 and 13, 15 located opposite each other in parallel. On the contact surfaces 12 to 15, two contact regions 110 spaced from each other are provided. An outer shell surface of a shaft portion with a square profile corresponding to the form-fit region 120 rests against these contact regions 110 of the respective contact surface 13 to 15, so that the shaft portion is enclosed by and positively accommodated in the form-fit region 120. During a rotation of an actuating shaft W introduced into the form-fit region 120 of the cutout 11 in this way, the seat component 10 thus is carried along and rotated.

The form-fit region of the cutout formed in the (first) partial region 10.2 is so large that an inner portion with a cross-sectional profile positively fitting into the form-fit region 120 can be introduced and inserted through this form-fit region of the partial region 10.2 into the form-fit region 120 square in cross-section of the (second) partial region 10.1 located behind the same. The internal dimensions of the cutout in the partial region 10.2 thus are such that a shaft portion fitting into the form-fit region 120 of the other partial region 10.1 can be guided past the form-fit region of the partial region 10.2 located before the same.

In the present case, the form-fit region in the partial region 10.2 is formed for positively accommodating a triangular profile and includes three segments 160, 170 and 180 in the form of recesses or pockets cup-like in cross-section, into each of which a nose or a correspondingly protruding portion (protrusion or web) provided on the shaft portion to be introduced can be inserted.

The individual segments 160, 170 and 180 of the form-fit region in the partial region 10.2 are spaced from each other along the circumference of the cutout 11 and connected with each other via intermediate regions 31, 32 and 33. The intermediate regions 31, 32 and 33 and the form-fit regions 160, 170 and 180 thus define a circumferential inner shell surface of the cutout 11 in the partial region 10.2.

The form-fit regions 160, 170 and 180 are arranged such that their centers M1, M2 and M3 form corner points of an imaginary equilateral triangle. The individual segments 160, 170 and 180 thus extend from a center of the cutout 11 radially to the outside and substantially at an angle each of 120 degrees relative to each other.

Each form-fit region 160, 170, 180 includes two mutually opposite functional surfaces 16a/16b, 17a/17b or 18a/18b, against which an introduced shaft portion which has a cross-sectional profile (triangular profile) adapted to the inner contour of the cutout 11 in the partial region 10.1 (at least partly) rests and introduces a torque into the seat component 10, when the actuating shaft W is rotated. During the rotation of the actuating shaft in one direction of rotation (anti-clockwise in FIG. 2B) the torque transmission each is effected to one functional surface 16a, 17a, 18a of a form-fit region 160, 170 and 180, and with an opposite direction of rotation (clockwise) to the opposite functional surface 16b, 17b, 18b.

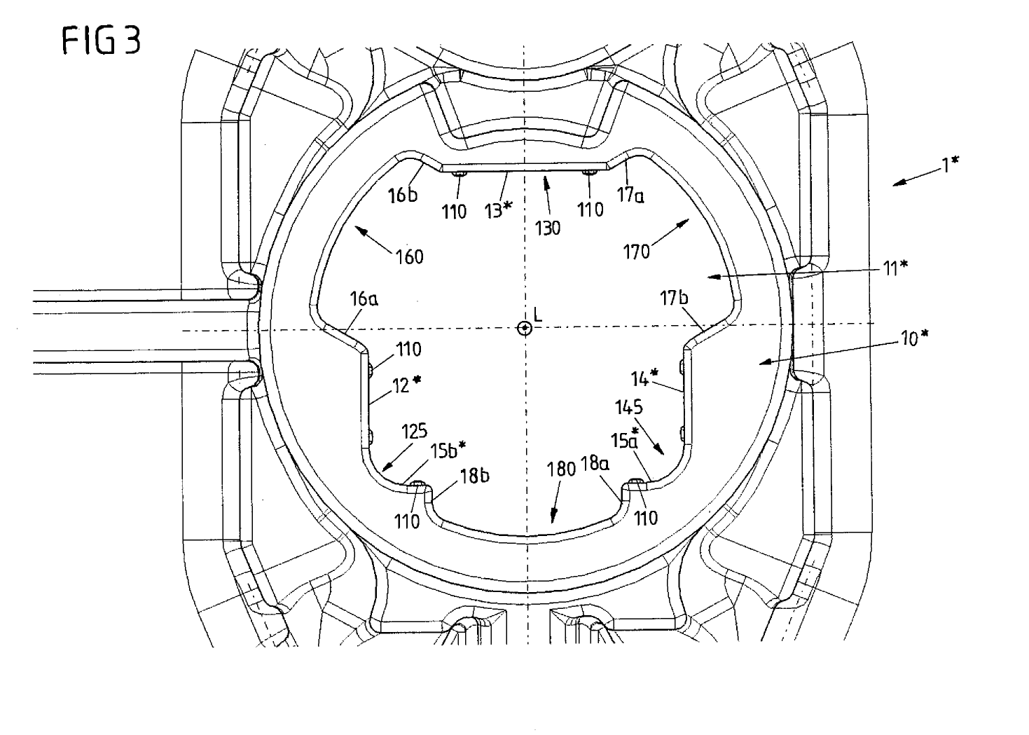

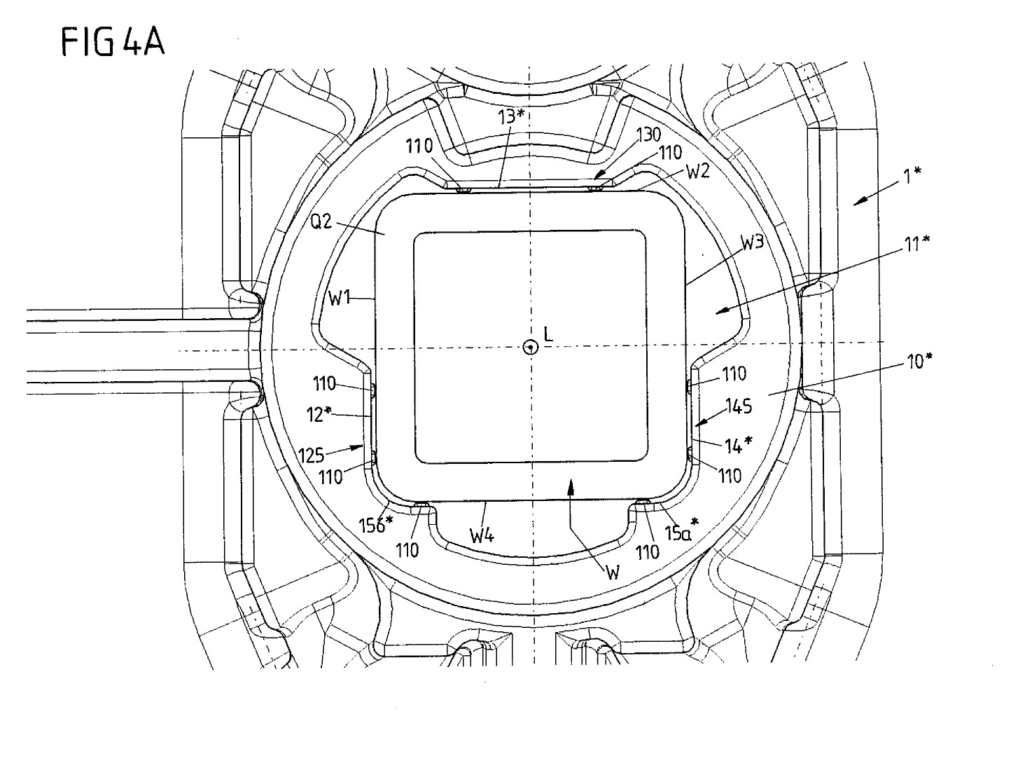

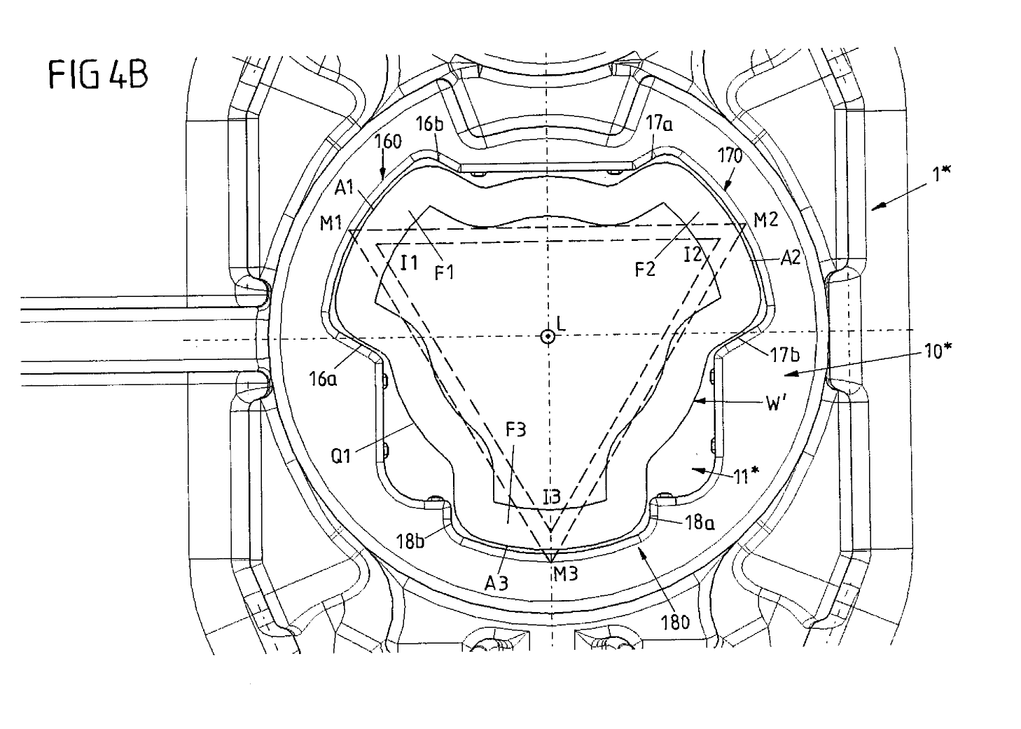

While in the embodiment of FIGS. 2A and 2B the cutout 11 of the seat component 10 combines two different profiles arranged one behind the other inside a common inner contour, the exemplary embodiment of FIGS. 3, 4A and 4B provides a seat component 10* with two profiles superimposed on each other in a cross-sectional view (FIG. 3) for positively accommodating shaft portions with two cross-sectional profiles Q1 and Q2 different from each other. The seat component 10* is provided in a seat fitting 1*, which otherwise is formed identical to the seat fitting 1 of the preceding Figures.

As can clearly be seen in particular with reference to FIG. 3, the seat component 10* includes a cutout 11* for accommodating a shaft portion of an actuating shaft W (FIG. 4A) or W′ (FIG. 4B) to be connected with the seat component 10*. The inner contour of the cutout 11* now is defined by two form-fit regions, which on the one hand are designed and provided for positively accommodating a square profile (form-fit region with segments 125, 130 and 145) and on the other hand for positively accommodating a triangular profile (segments 160, 170 and 180). Thus, a multi-functional receptacle profile is provided inside the cutout 11*.

The segments of the two form-fit regions for the cross-sectional profiles different from each other alternate along the inner circumferential surface of the cutout 11*, so that a segment 160, 170, 180 of the form-fit region for a first cross-sectional profile (triangular profile) each is followed by a segment 130, 145, 125 of the form-fit region for the second cross-sectional profile (square profile). In the cross-sectional view through the cutout 11* as shown in FIG. 3, the individual segments 125, 130, 145 and 160, 170, 180 for the different cross-sectional profiles of a shaft portion thus lie within a common sectional plane which extends vertical to the insertion direction or the direction of longitudinal extension L of the respective actuating shaft W, W′.

The individual segments 160, 170, 180 of a first form-fit region for a first cross-sectional profile Q1 (cf. FIG. 4B) are designed identical to the form-fit regions corresponding to FIG. 2B. In the present embodiment, they are now furthermore completed by segments 125, 130 and 145 of a second form-fit region for a second cross-sectional profile Q2 (cf. FIG. 4A), so that in the cross-section of the cutout 11* two geometrically differently designed form-fit regions are superimposed on each other in the inner contour of the cutout 11*. The intermediate regions 31, 32 and 33 of the embodiment of FIG. 2B thus have been omitted and replaced by the segments 125, 130 and 145 for accommodating a shaft portion with an alternative cross-sectional profile.

Two opposite segments 125 and 145 for the second cross-sectional profile Q2 (square profile) each are formed L-shaped. The two segments 125, 145 form two functional surfaces 12* and 14* parallel to and facing each other as well as functional surfaces 15b* and 15a* substantially vertical thereto and pointing towards each other. Thus, the two opposite segments 125, 145 together form a part of a U-shaped receptacle, in which two adjacent corner portions of a square profile each are enclosed by two sides. With two mutually vertical portions W1 and W4 or W3 and W4 of an outer shell surface, a shaft portion with a corresponding rectangular, in particular square cross-sectional profile Q2 as shown in FIG. 4A thus rests against the functional surfaces 12* and 15b* of a segment 125 or against the functional surfaces 14* and 15a* of a segment 145 via contact regions 110.

Furthermore, a further portion W2 of the outer shell surface of the introduced shaft portion, which is located opposite the portion W4 of the outer shell surface supported by the two segments 125 and 145, rests against contact regions 110 of a functional surface 13* of the segment 130. In this way, a shaft portion with the cross-sectional profile Q2 can be inserted or introduced into the cutout 11* and thereby is positively retained in the cutout 11*.

Via the further segments 160, 170 and 180, this is also given for a shaft portion of an actuating shaft W′ with a triangular profile (first cross-sectional profile Q1). This is illustrated above all with FIG. 4B.

Thus, such shaft portion of an actuating shaft W′ includes three noses or tabs F1, F2 and F3 each pointing radially to the outside and offset relative to each other by 120 degrees along the circumference of the actuating shaft W′. The segments 160, 170 and 180 of the one form-fit region of the cutout 11* are formed such that these tabs F1, F2 and F3 each can be inserted and positively accommodated in a recess each defined by the segments 160, 170 and 180. The geometrical dimensions of the individual segments 160, 170 and 180 thus correspond with the dimensions of the tabs F1, F2 and F3 of the shaft portion with the first cross-sectional profile Q1.

Correspondingly, the actuating shaft W′ with the portions A1, A2, A3 formed on the tabs F1, F2 and F3 of the outer shell surface of the actuating shaft W′ can slidingly be introduced into the cutout 11 along the three segments 160, 170 and 180 of the form-fit region formed thereby and via the same is positively held in the cutout 11*, without a deformation of the seat component 10* or of the actuating shaft W′ being required.

To illustrate that by the segments 160, 170 and 180 a (receptacle) profile adapted to the cross-sectional profile Q1 (triangular profile) is provided inside the inner contour of the cutout 11*, two geometrically similar, equilateral imaginary triangles are depicted in FIG. 4B. The centers of the tabs F1, F2 and F3 of the actuating shaft W′ lie at corner points I1, I2 and I3 of an imaginary equilateral (inner) triangle. Centers M1, M2 and M3 of the segments 160, 170 and 180 have defined corner points of a further imaginary equilateral (outer) triangle. This outer triangle is not geometrically congruent, but geometrically similar to the inner triangle, with the sides thereof merely being longer. Accordingly, a space is left between a segment 160, 170, 180 and the respective portion A1, A2, A3, so that the shaft portion with the cross-sectional profile Q1 can smoothly be inserted into the cutout 11*.

With the inventive configuration of a seat component 10, 10* or an assembly with such seat component 10, 10* and an actuating shaft W, W′ it thus is possible that two shaft portions with different cross-sectional profiles Q1, Q2 can slidingly be introduced into a cutout 11, 11* of the seat component 10, 10* and each of the shaft portions with one of the specified cross-sectional profiles Q1, Q2 can be or is positively accommodated and retained in the cutout 11, 11*. Thus, for example an assembly with a set of actuating shafts W, W′ with different cross-sectional profiles Q1, Q2 can be provided, in which both can be combined with a single seat component 10*. The cutout 11* of the seat component 10* here includes a multi-functional inner contour, for example the inner contour shown in the cross-sectional views of FIGS. 3, 4A and 4B, which inner contour reveals both cross-sectional profiles Q1 and Q2, so that both actuating shafts W and W′ are easily positively connectable with the seat component 10*.

In contrast to the exemplary embodiments illustrated in the preceding Figures, it is of course also possible to design a cutout of a seat component such that both a shaft portion or an actuating shaft with a square profile and a shaft portion or an actuating shaft with a pentagonal profile can slidingly be introduced into the cutout and can positively be accommodated therein. For the pentagonal profile, e.g. merely four segments would be formed in the form of radial recesses and be arranged relative to each other such that a shaft portion with a cross-sectional profile which substantially corresponds to an imaginary regular pentagon can positively be retained therein.

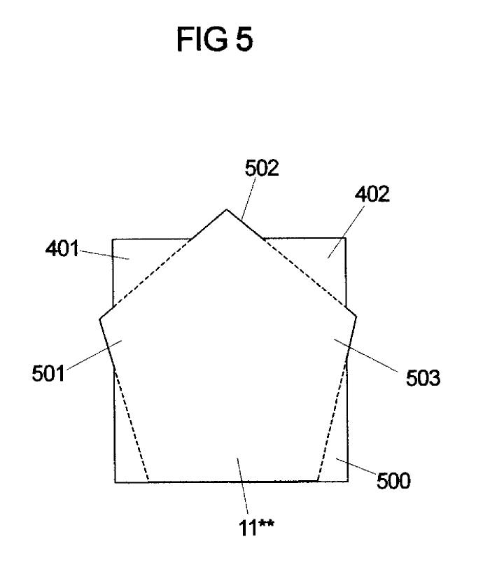

Such example is schematically shown in FIG. 5.

In this Figure, a (lower) segment 500 is represented U- or cup-shaped in a cross-sectional view corresponding to FIG. 3, so that both the shell surface W4 of the square profile (cross-sectional profile Q2) and a parallel shell surface of the pentagonal profile can rest against a horizontal functional surface. Along the circumference of the corresponding cutout 11**, a total of five more substantially triangular segments 501, 401, 502, 402 and 503 then follow one beside the other. The segments 501, 502 and 503 of the form-fit region for the pentagonal profile alternate with the segments 401 and 402 of the form-fit region for the square profile.

Furthermore, it is conceivable that a seat component is provided with a cutout which has an inner contour adapted to three different cross-sectional profiles. Thus, a seat component 10* corresponding to FIG. 3 (or FIG. 5) could still have a partial region 10.1 corresponding to FIG. 2A in direction of extension or direction of longitudinal extension L. Such seat component correspondingly could positively accommodate a triangular profile in a first form-fit region (segments 160, 170, 180) and two square profiles with different dimensions in a second form-fit region (segments 125, 130, 145) and a third form-fit region (segment 120).

Here, an aspect essential for the invention also would be that a plurality of different shaft profiles are formed in a single inner contour in the cutout of a seat component and hence a positive connection is made by inserting a shaft portion with one of the permitted, suitable cross-sectional profiles without additional deformation.

In particular with regard to the exemplary embodiment of FIGS. 3, 4A and 4B, in which along the circumference of an inner shell surface segments for different form-fit regions are arranged one beside the other and hence lie in a common cross-sectional plane of the cutout, these segments preferably are arranged and formed such that when a shaft portion with a first cross-sectional profile Q1 (Q2) is introduced, the same does not rest against the segments which are associated to the form-fit region for a shaft portion with the second cross-sectional profile Q2 (Q1). Thus, the inserted shaft portion of the one actuating shaft W′ with the first cross-sectional profile Q1 (triangular profile) does not act on the segments 125, 130 and 145, just like the shaft portion of the other actuating shaft W with the second cross-sectional profile Q2 (square profile) does not act on the segments 160, 170 and 180.

1. A seat component for a seat, in particular a vehicle seat, which is connectable with an actuating shaft such that a rotary movement of the actuating shaft can be transmitted to the seat component, wherein:
the seat component includes a cutout for connection with an actuating shaft,
an inner contour of the cutout is adapted to at least two cross-sectional profiles different from each other, so that a shaft portion of an actuating shaft with a first cross-sectional profile or a shaft portion of an actuating shaft with at least one further, second cross-sectional profile can selectively be introduced into the cutout and be connected with the seat component, and
the cutout includes at least two geometrically differently designed form-fit regions each for one of the at least two cross-sectional profiles, which are formed such that each shaft portion with one of the at least two cross-sectional profiles can slidingly be introduced into at least one, respectively suitable form-fit region and is positively accommodated therein.

2. The seat component according to claim 1, wherein the at least two form-fit regions each are formed and provided for the purpose that a shaft portion with one of the at least two cross-sectional profiles, which is introduced into the cutout, is exclusively positively accommodated in a form-fit region and/or that each shaft portion with one of the at least two cross-sectional profiles can be inserted into at least one form-fit region.

3. The seat component according to claim 1, wherein at least one form-fit region for a cross-sectional profile each includes a plurality of segments spaced from each other.

4. The seat component according to claim 3, wherein at least two form-fit regions each include a plurality of segments and the segments are formed and arranged such that in a first shaft portion with a first cross-sectional profile to be connected with the seat component first segments positively accommodate the first shaft portion and in a second shaft portion with a second cross-sectional profile different from the first cross-sectional profile the second shaft portion is positively accommodated by segments which are different from the first segments.

5. The seat component according to claim 1, wherein segments for a first cross-sectional profile and segments for a second cross-sectional profile are arranged one beside the other along an inner shell surface of the cutout, which at least partly surrounds a shaft portion of an actuating shaft connected with the seat component as intended.

6. The seat component according to claim 5, wherein a plurality of segments for two different cross-sectional profiles are alternately arranged along the inner shell surface of the cutout.

7. The seat component according to claim 5, wherein in a cross-sectional view through the cutout the segments for the different cross-sectional profiles at least partly lie within a sectional plane which extends substantially vertical to an insertion direction along which the shaft portion of the actuating shaft to be connected with the seat component must be introduced into the cutout.

8. The seat component according to claim 1, wherein at least one form-fit region for a first cross-sectional profile and at least one form-fit region for a second cross-sectional profile are arranged one behind the other along a direction of extension of the cutout, wherein this direction of extension extends substantially parallel to an insertion direction along which the shaft portion of an actuating shaft to be connected with the seat component must be introduced into the cutout.

9. The seat component according to claim 1, wherein the inner contour of the cutout is formed for positively accommodating a shaft portion with a substantially rectangular cross-sectional profile, in particular with a square profile.

10. The seat component according to claim 9, wherein the inner contour of the cutout is formed for positively accommodating a shaft portion with substantially rectangular cross-sectional profile and a shaft portion with triangular profile or pentagonal profile.

11. The seat component according to claim 1, wherein the seat component is formed and provided as part of a seat fitting for a seat, in particular such that on the seat fitting arranged on one side of the seat at least two shaft portions with different cross-sectional profiles selectively are positively connectable as intended by means of the seat component.

12. An assembly for a vehicle seat in which a first vehicle part is pivotable relative to a second vehicle part, wherein the assembly comprises an actuating shaft and at least one seat component, in particular a seat component according to claim 1, and wherein:
the seat component is connectable with the actuating shaft such that a rotary movement of the actuating shaft can be transmitted to the seat component, in order to provide for swiveling the first vehicle part of the vehicle seat relative to the second vehicle part of the vehicle seat,
an inner contour of the cutout is adapted to at least two cross-sectional profiles different from each other, so that a shaft portion of an actuating shaft with a first cross-sectional profile or a shaft portion of an actuating shaft with at least one further, second cross-sectional profile can selectively be introduced into the cutout and non-rotatably be connected with the seat component, and
the cutout includes at least two geometrically differently designed form-fit regions each for one of the at least two cross-sectional profiles, which are formed such that each shaft portion with one of the at least two cross-sectional profiles can slidingly be introduced into at least one, respectively suitable form-fit region and is positively accommodated therein.

13. The assembly according to claim 12, wherein the assembly comprises a set of at least two actuating shafts and the shaft portions of the at least two actuating shafts, which each are provided for the positive connection with the at least one form-fit region, include the cross-sectional profiles different from each other, so that each of the at least two actuating shafts selectively can positively be connected with the seat component via the cutout.

14. The assembly according to claim 12, wherein the assembly comprises an actuating shaft which includes at least two shaft portions arranged one behind the other along its direction of longitudinal extension, which
both can be introduced into the cutout of the seat component along an insertion direction,
have cross-sectional profiles different from each other, and
each can positively be accommodated in at least one of the form-fit regions of the cutout,
wherein in dependence on the length with which the actuating shaft still protrudes from the cutout against the insertion direction the one or the other of the at least two shaft portions positively engages in the cutout.
